(19) United States
(12) Patent Application Publication
(10) Pub. No.: US 2009/0040934 A1
(43) Pub. Date: Feb. 12, 2009

(54) Distributed System

(75) Inventors: Masahiro Matsubara, Tokai (JP); Kohei Sakurai, Munchen (DE); Kotaro Shimamura, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/184,447

(22) Filed: Aug. 1, 2008

(30) Foreign Application Priority Data
Aug. 6, 2007 (JP) 2007-203755

(51) Int. Cl. G06F 11/00

(52) U.S. Cl. 370/242

(57) ABSTRACT

Mutual node-fault monitoring keeps the values of abnormality counters, which keep track of error occurrences, consistent among all nodes. However, in some cases, the counter values may become inconsistent among the nodes depending on the error situation.

In a distributed system having a plurality of nodes connected via a network, each of the plurality of nodes includes: an error monitor unit for monitoring an error in each of the other nodes; a send/receive unit for sending and receiving data for detecting abnormalities in the other nodes, to and from each of the other nodes via the network, thereby exchanging error monitor results; an abnormality determination unit for determining a node abnormality based on the exchanged error monitor results; a counter unit for counting occurrences of the abnormality for the node determined as having the abnormality; and a counter synchronization unit for synchronizing abnormality counter values after exchanging the counter values with each of the other nodes.

### CLAIM OF PRIORITY

The present application claims priority from Japanese patent application serial No. 2007-203755, filed on Aug. 6, 2007, the content of which is hereby incorporated by reference into this application.

### FIELD OF THE INVENTION

The present invention relates to control systems in which a plurality of devices connected via a network cooperate with each other to control the system.

### BACKGROUND OF THE INVENTION

In recent years, vehicle control systems have been developed to improve the drivability and safety of automobiles. In such systems, an operation of a driver such as acceleration, steering and braking is conveyed to a mechanism, not through mechanical coupling but through electronic control, to generate a corresponding vehicle force. In such systems, a plurality of electronic control units (ECUs) displaced throughout a vehicle cooperate with each other by exchanging data via a network. It is essential to the fail-safety of such systems that when a failure occurs in one of ECUs in the network, the remaining normal ECUs correctly locate the faulty ECU and perform a suitable backup control depending on the situation. To provide such mechanism, Patent Document 1 discloses a technique in which each node comprising a system (processing unit such as ECU) monitors the other nodes in a network.

Patent Document 1: Japanese Patent Laid-open No. 2000-47894

### SUMMARY OF THE INVENTION

According to Patent Document 1, an extra node (shared disk) is required for sharing monitored information (such as an operating status of a database application) among nodes. However, if such a shared disk fails, the node-fault monitoring in the system can no longer be continued. In addition, providing such a shared disk will unfavorably increase the cost of the system.

To address such problems, the following methods can be employed. For example, each node may independently monitor error items for another node and exchange the error monitor results with all the other nodes via a network to make a final determination of any abnormalities based on the gathered error monitor results. It is also possible to synchronize all the nodes or detect any inconsistencies among the nodes by exchanging such abnormality determination results via a network. An abnormality counter keeps track of error occurrences, and when the counter reaches a specified threshold value, an error occurrence notification is sent to its control application. Receiving such an error notification, the control application can execute, depending on the situation, error procedures such as shifting to a backup control status.

Values of abnormality counters will be basically consistent among nodes by using such mutual node-fault monitoring as described above. However, the values of the abnormality counters may become inconsistent among the nodes in some cases such as when one of the nodes is reset or when error monitor results or abnormality determination results cannot be exchanged due to a communication failure.

Inconsistency in the abnormality counter values among the nodes can cause error notifications to be sent at different times, causing the nodes to shift to backup control at different times. Transition to the control mode must be done in sync among all the nodes to maintain the safety and stability of a vehicle. For example, with a brake-by-wire (hereinafter, BBW) system, extremely imbalanced brake forces on wheels may cause the vehicle to skid.

To avoid such a problem, all the abnormality counters must be kept in synch. One method to synchronize all the counters is that when a counter of a node reaches a certain level, the node sends a notification to the other nodes. For example, if a node is set to send an error notification at the counter value of “10” and when the counter value of the node becomes “9”, the node can notify its status to the other nodes by setting a specific bit in its transmission data and send the data to the other nodes in the next communication cycle and on. Hereinafter, this specific bit is called “an error-notification imminent flag”, and this synchronization of abnormality counters using the imminent flag is called “imminent flag synchronization”.

If each node, after receiving the imminent flag from a faulty node whose counter is near-limit, and consequently synchronizing its counter value to the value of the faulty node, identifies an error in the faulty node through mutual node-fault monitoring, the counter for the faulty node in the node becomes “10”. This will make each and all nodes in a system to send an error notification at the same time, therefore enabling the nodes to switch to backup control all at the same time.

As described above, the imminent flag synchronization is a simple and easy method to use; however, it may not be very robust in a way. If an imminent flag is wrongly set by some kind of failure, a counter value of each node which has received the flag will be significantly changed. This increase in counter value may be considered as a safe practice; however, it decreases system availability and it might even decrease system reliability.

An object of the present invention is to solve the above problem and to provide a distributed system in which a plurality of devices connected via a network cooperate with each other to control the system.

To solve this problem, the system in the present invention is configured as follow: Each node having its own abnormality counters mutually monitors each other; exchanges numbers of error occurrences (hereinafter, “abnormality counter values”) which are kept track by abnormality counters; and when a specific condition is met, synchronizes its counters with the others by matching the counter values to the values of the other nodes or to the values calculated from the other nodes' values. This method is called an abnormality-counter transmission synchronization method.

In the present invention, a system for performing the abnormality-counter transmission synchronization is configured as a distributed system having a plurality of nodes connected via a network, each of the plurality of nodes includes: an error monitor unit for monitoring an error in each of the other nodes; a send/receive processing unit for sending and receiving data for detecting abnormalities in the other nodes, to and from each of the other nodes via the network, thereby exchanging error monitor results; an abnormality determination unit for determining a node abnormality based on the exchanged error monitor results; a counter unit for counting occurrences of the abnormality for the node determined as having the abnormality; and a counter synchronization unit for synchronizing abnormality counter values after exchanging the counter values with each of the other nodes.

From above, the present invention can achieve a more robust distributed system because the abnormality-counter synchronization will allow each node to be synchronized at any counter values while in an imminent-flag synchronization method; each node is synchronized only at a specific counter value.

With the present invention, the abnormality-counter synchronization among nodes will become robust, allowing each node to send an error notification to its control application at the same time among the nodes. This method can improve system availability by avoiding an unnecessary error notification and a resulting transition to backup control, so that the system reliability can also be maintained high.

### BRIEF DESCRIPTION OF THE DRAWINGS

FIG. 1 is a block diagram of a distributed system.

FIG. 2 is a flow chart of abnormality-counter transmission synchronization.

FIG. 3 is a detailed flow chart of abnormality-counter synchronization condition determination and execution processes.

FIG. 4 is a flow chart of abnormality determination processes with mutual node-fault monitoring.

FIG. 5 is a rotation schedule of target nodes.

FIG. 6 illustrates an exemplary operation of mutual node-fault monitoring.

FIG. 7 illustrates an exemplary operation of mutual node-fault monitoring.

FIG. 8 illustrates an exemplary operation of mutual node-fault monitoring.

FIG. 9 is a flow chart of abnormality determination processes with mutual node-fault monitoring.

FIG. 10 is a rotation schedule of target nodes.

FIG. 11 illustrates an exemplary operation of mutual node-fault monitoring.

FIG. 12 illustrates an exemplary operation of mutual node-fault monitoring.

### DESCRIPTION OF THE PREFERRED EMBODIMENTS

Embodiments of the present invention are described below referring to figures.

### Embodiment 1

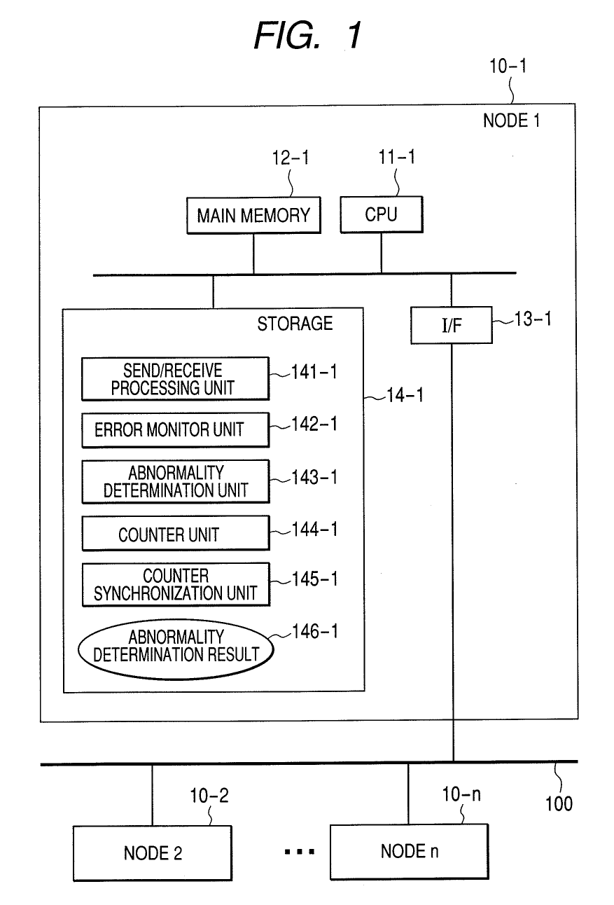

FIG. 1 is a block diagram of a distributed system.

The distributed system includes a plurality of nodes 10 (10-1, 10-2, . . . , 10-n), which are connected to each other via a network 100. The node is a processing unit that can exchange information with the other nodes via a network, and includes various electrical control units such as a CPU, actuators and their drivers, sensors, etc. The network 100 is a multiplex transmission network, in which a node can simultaneously broadcast the same information to all the other nodes connected to the network.

Each node i (i: node number, i=1 . . . n) includes a CPU 11-i, a main memory 12-i, an I/F 13-i, and a storage 14-i, all of which are connected to each other via an internal communication line and the like. The I/F 13-i is connected to the network 100.

The storage 14-i stores programs such as a send/receive processing unit 141-i, an error monitor unit 142-i, an abnormality determination unit 143-i, a counter unit 144-i, and a counter synchronization unit 145-i, as well as an abnormality determination result 146-i. The abnormality determination result 146-i includes a monitor result table and an abnormality determination result table, which are described later.

The CPU 11-i executes various processes by loading these programs into the main memory 12-i. The programs and data described herein may be prestored in the storage, inputted from a storage medium such as a memory card, or downloaded from another system via a network. In addition, the functions performed by the programs may be implemented using dedicated hardware. In the following descriptions, various processes are performed by the programs; however, they are actually the CPUs that perform such processes.

The send/receive processing unit 141-i sends and receives, via the network 100, data for detecting node abnormalities, error monitor results, and the like. The error monitor unit 142-i monitors errors (MON) based on the data for detecting node abnormalities, and sends the result to the other nodes using the send/receive processing unit 141-i. The abnormality determination unit 143-i identifies abnormalities based on the error monitor results obtained by its own node and by the other nodes; the error monitor results by the other node have been received by the send/receive processing unit 141-i. The counter unit 144-i counts, for each abnormality type, the number of abnormalities for the faulty node identified through the abnormality identification process. The counter synchronization unit 145-i sends the abnormality counter values in its own node to the other nodes using the send/receive processing unit 141-i, and only when the abnormality counter values from the other nodes received by the send/receive processing unit 141-i meet a condition which will be described later, synchronizes its own abnormality counter values with the values from the other nodes.

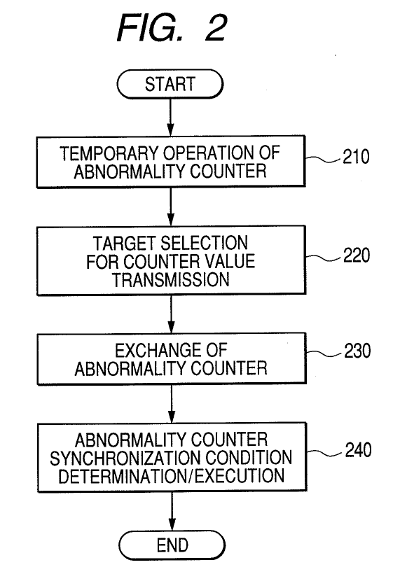

FIG. 2 shows a flow chart for the abnormality-counter transmission synchronization. These processes are performed in sync among all nodes (counter synchronization units 145-i to be more precise), e.g. for every communication cycle, while communicating with each other via the network 100.

In step 210, depending on the presence or absence of an error for each node and error type, which has been identified through an error identification process, abnormality counter values are changed to temporary counter values. The information used for identifying an error, based on which counter values are changed, and the timing of changing the counter values may vary depending on the mutual monitoring methods; hence they will be described later. The changed counter values are temporary until they are finalized through a counter synchronization process in step 240.

In step 220, the abnormality counter values to be sent to the other nodes are selected. That is, the counter values of which node and which error type to include in the transmission data are decided. The selection method may vary depending on the mutual monitoring methods; hence it will be described later.

In step 230, the send/receive processing unit 141-i sends and receives to and from (exchanges with) the other nodes, via the network 100, the temporary abnormality counter values obtained in step 210.

Step 240 determines whether or not a condition for abnormality-counter synchronization is met, based on the counter values received from the other nodes in step 230 and the counter values in its own node. If the condition is met, the counter values in its own node are set to the values (hereinafter, “synchronization counter values”) calculated from the exchanged counter values. As a result, abnormality counters are synchronized among all the nodes. There are different abnormality-counter synchronization conditions and ways to calculate the synchronization counter values; hence they will be described later.

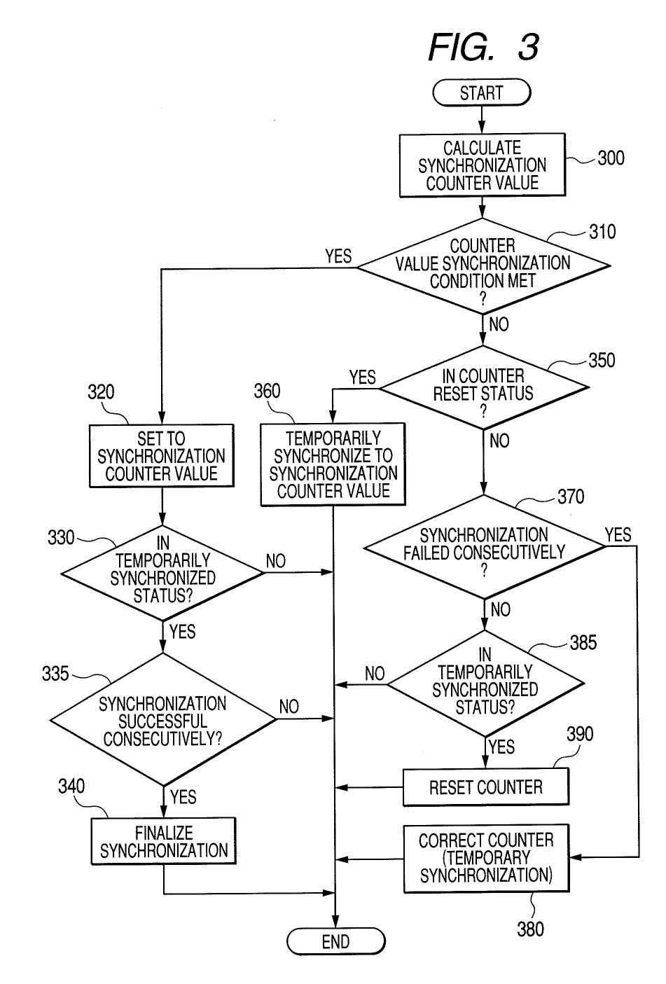

FIG. 3 is a process flow chart showing the detail of “abnormality-counter synchronization condition determination/execution”, i.e. step 240 in FIG. 2. These processes are performed for each abnormality counter, or in other words, for each node, communication channel, and error type the abnormality counter keeps track of.

In step 300, synchronization counter values are calculated from the counter values received from the other nodes in step 230 and from the counter values in its own node.

Step 310 determines whether or not a condition for abnormality-counter synchronization is met, based on the counter values received from the other nodes in step 230, the counter values in its own node, or the synchronization counter values calculated in step 300. If the synchronization condition is met, the process moves on to step 320, or else, it goes to step 350.

In step 320, the abnormality counter values in its own node are modified and set to the synchronization counter values calculated in step 300. No modifications are necessary if the synchronization counter values are the same as the counter values in its own node.

Step 330 determines whether or not the abnormality counter values in its own node are in a temporarily synchronized status. The temporarily synchronized status refers to the state in which the counter values in its own node are matched with the synchronization counter values but not finalized yet. If the counters are in a temporarily synchronized status, the process goes to step 335, or else, it ends.

Step 335 determines if the abnormality counters to be synchronized (hereinafter, “synchronization target abnormality counters”), have been successfully and consecutively synchronized for a specified number of times, or in other words, whether or not the synchronization condition in step 310 has been met. If the answer is yes, the process moves on to step 340 to finalize the synchronization and cancel the temporarily synchronized status. Then the process will end. If the consecutive synchronization has not been successfully performed for the specified number of times, the counters remain in the temporarily synchronized status, and the process will end. The specified number mentioned above should be preset in the software by a designer.

Step 350 determines whether or not the synchronization target abnormality counters are in a counter reset status. The following two cases are possible to determine the counter reset status.

(1) The counter value is “0”.

(2) The reset flag is valid (the bit is turned on).

A counter reset status will be obtained when a node finds an abnormality in itself through self diagnosis or mutual monitoring, and resets itself by clearing its counters. If the node is in a counter reset status, the process moves on to step 360, or else, it goes to step 370.

In step 360, the counter values in its own node are temporarily synchronized with the synchronization counter values. Because of this process, the counters can be synchronized even when the abnormality-counter synchronization condition is not met due to their counter reset status (e.g., after a node reset). Then the process will end.

Contrary to step 335, step 370 determines if the abnormality counters have consecutively failed to be synchronized for a specified number of times, or in other words, if the synchronization condition in step 310 have failed to be satisfied. If the answer is yes (consecutively failed), the process goes to step 380, or else, it goes to step 385.

In step 380, based on the grounds that the counter synchronization has consecutively failed due to an error in the abnormality counters in its own node, the counter values in the node are corrected by temporarily synchronizing them with the synchronization counter values. Then the process will end.

Step 385 determines if the synchronization target abnormality counters are in a temporarily synchronized status. If they are in the temporarily synchronized status, the process goes to step 390, or else, it ends.

In step 390, based on the grounds that the counter values in the temporarily synchronized status are wrong, the synchronization target abnormality counters are reset.

For the calculation of the synchronization counter values, the following methods may be used. One method is when there is only one node reporting an abnormality for a certain node and an error type, the abnormality counter value sent by the node is employed as the synchronization counter value. When the reporting node is itself, it would be the value of its own counter. Another method is when there are a plurality of nodes reporting an abnormality for a certain node and an error type, the abnormality counter values sent by these nodes may be averaged and rounded to whole numbers, or a majority vote may be taken, or yet, the median or maximum values of the counter values may be calculated.

For the abnormality-counter synchronization conditions, the following may be used. One condition is that the synchronization counter value must have a small difference compared to the counter value in its own node. More specifically, “(abnormality-counter synchronization condition 1): the calculated synchronization counter value must be within +k to −m (k=1, 2, 3 . . . , m=0, 1, 2 . . . ) from the counter value in its own node.” Another condition is that “(abnormality-counter synchronization condition 2): the synchronization counter value must have only a small difference, i.e. must be within +k′ to −m′ (k′=1, 2, 3 . . . , m′=0, 1, 2 . . . ) compared to the synchronization counter value calculated in the previous synchronization process.” The k, m, k′, and/or m′ are preset in the software by a designer.

Yet another condition is that when taking a majority vote or calculating the median value of a plurality of received counter values for the synchronization counter value, “(abnormality-counter synchronization condition 3): the synchronization counter value must be calculated successfully.” In other words, if the synchronization counter value is calculated successfully, the abnormality-counter synchronization condition is satisfied. These abnormality-counter synchronization conditions may be set in different ways such as that only one of the conditions is required to be satisfied for performing abnormality-counter synchronization or that a plurality of conditions must be satisfied to perform the synchronization.

The mutual error monitoring (MON) detects errors in its own node or in the other nodes. Errors during the abnormality-counter synchronization processes in FIG. 2 and FIG. 3 may be added as a monitoring item for the error monitoring (MON) process.

For example, if an abnormality-counter synchronization condition is not met in step 310, the error monitor unit 142-i may determine that the node sending the counter value related to the synchronization target abnormality counter is “having an error”. The node determined as “having an error” in this abnormality identification process using the error monitor results will reset its synchronization target abnormality counter to be easily and correctly synchronized later.

In addition, if a node has consecutively failed to synchronize for a specified number of times in step 370 for example, the node may be determined as “having an error.”

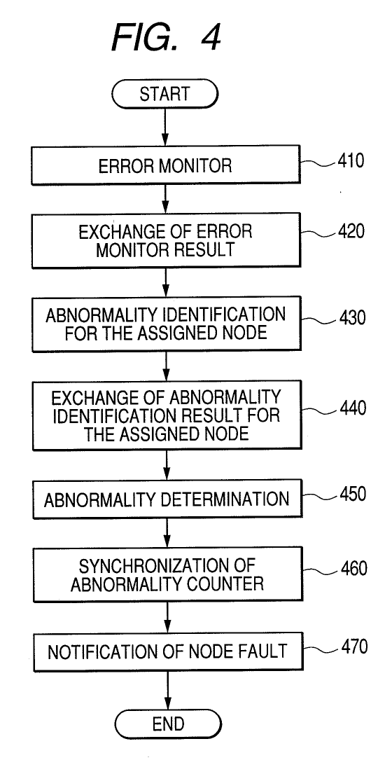

FIG. 4 shows a flow chart of abnormality determination processes with mutual node-fault monitoring. These processes are performed in sync among all the nodes, e.g. for every communication cycle, while communicating with each other via the network 100.

In step 410, the error monitor unit 142-i monitors errors (MON) in the other nodes. It independently determines errors in each node based on the received data and receiving status. It also monitors errors in its own node through self diagnosis.

A plurality of error items (hereinafter, “error monitor items”) may be set for monitoring. For example, in “reception error” monitoring, an error in the sending node is identified when there is a data-reception-related error such as an incomplete reception or a misdetection found by an error-detection-code. In “serial number error” monitoring, an error in the sending node is identified when the receiving node detects that a serial number in the transmitted data, which must be incremented by the sending node for each communication cycle, is not incremented. The serial number is for identifying an error in an application of the sending node. In “self diagnosis error” monitoring, each node sends to the other nodes the diagnosis result for its own node (hereinafter, self-diagnosis result), so that each receiving node can identify an error in the sending node based on the received self-diagnosis result. The “self-diagnosis error” and “serial number error” may be combined as a single monitor item. In this case, when there is an error in either of the two, the error in the combined error monitor item is determined.

Then, in step 420, the send/receive processing unit 141-i sends and receives, via the network 100, the error monitor (MON) results obtained in step 410, and exchanges the data with the other nodes (EXD1). As a result, each node acquires the error monitor results from all other nodes including itself. The gathered error monitor results are written in the error monitor result table.

Next in step 430, the abnormality determination unit 143-i identifies errors (ID1) from the error monitor (MON) results gathered in each node in step 420. Each node is responsible for one other node participating in the mutual monitoring, to identify error occurrences in the node. There should not be any overlaps in node assignment, and the assignment is rotated for every communication cycle. In this way, the load in the abnormality identification process is decreased by distributing the load among all the nodes.

For the abnormality identification (ID1), the number of nodes reporting an error for each error monitor item for the assigned node is counted from the gathered error monitor (MON) results, and a majority vote is taken. If the number of the error-reporting nodes gets the majority, the assigned node is identified as having an abnormality for the error monitor item. In a majority vote, a threshold value is half of the total number, but the threshold may be specified to any other numbers. In that case, when the number of error-reporting nodes (number from the error monitor results) exceeds the specified number, the assigned node is identified as “having an error”.

Then, in step 440, the send/receive processing unit 141-i sends and receives, via the network 100, the abnormality identification (ID1) results for the one node assigned in step 430, and exchanges the data with the other nodes (EXD2). As a result, each node acquires the abnormality identification results from all the nodes including itself.

Next, in step 450, the abnormality determination unit 143-i determines abnormalities (ID2) from the abnormality identification (ID1) results gathered in each node in step 440. This finalizes the error determination. The abnormality determination results are written in the abnormality determination result table.

Next in step 460, the counter synchronization unit 145-i synchronizes abnormality counters. When the abnormality-counter transmission synchronization method is used for synchronization, the processes in FIG. 2 will be performed in step 460. In addition, the counter unit 144-i allows the original abnormality counters to reflect the counter values after the abnormality-counter synchronization process.

In the abnormality-counter transmission synchronization process, abnormality counters are first temporarily operated (step 210). In this step, the abnormality counters are operated based on the abnormality determination (ID2) results in step 450. The operated counter values are stored in a different region than the original abnormality counters.

For the operation method of abnormality counters, if an abnormality is determined in the abnormality determination (ID2) process, the abnormality counter value for the error monitor item for the error-determined node is incremented. On the contrary, if no abnormality is determined, the abnormality counter value may be decremented or reset. Whether to decrement, reset or do nothing with the counter for the node with no abnormalities should be preset in the software.

Next, in step 470, when the abnormality counter value exceeds a specified threshold, the counter unit 144-i notifies its control application of the error occurrence. One method of the error notification is to set a node-fault flag corresponding to each error monitor item for the error-determined node. A control application can be informed of the error occurrence by accessing such node-fault flags. After the node-fault flag has been set, an interrupt may be asserted to the control application or a callback function may be called to immediately notify the control application of the error occurrence.

Error notification is completed in step 470, or if there is no notification to send, the process will end.

The abnormality identification (ID1) is based on a majority vote as described above to determine any abnormalities. This process includes the following two conditions for abnormality determination (hereinafter, “abnormality determination conditions”).

When a node j is checked for an error based on error monitor (MON) results from each node, if a number of nodes that detected an abnormality (number in the error monitor results) is “(abnormality determination condition 1): equal to or greater than a threshold, the node j is determined as having an abnormality,” or else, if the number of nodes that detected the abnormality is “(abnormality determination condition 2): less than the threshold, the node that detected the abnormality in the node j is determined as having an abnormality.” A node for which no nodes detected an abnormality is determined as having no abnormalities.

An abnormality counter may be set for each abnormality determination condition. In this case, an abnormality determination result table should also be created for each abnormality determination condition. In step 460, the abnormality counter corresponding to each abnormality determination condition is operated, and the counter is synchronized for each abnormality determination condition. Hereinafter, the abnormality counter corresponding to the abnormality determination condition 1 is called a “majority-voted abnormality counter”, and the abnormality counter corresponding to the abnormality determination condition 2 is called a “minority-voted abnormality counter” for convenience.

In the same manner, in step 470, the information regarding the abnormality determination condition can be sent with a node-fault notification to a control application. In other words, node-fault flags can be divided not only by node numbers and error monitor items but also by abnormality determination conditions. Hereinafter, the situation where a majority-voted abnormality counter value exceeds a threshold, consequently turning the corresponding node-fault flag on is called “majority-voted abnormality” for convenience. Likewise, the situation where a minority-voted abnormality counter value exceeds a threshold, consequently turning the corresponding node-fault flag on is called “minority-voted abnormality” for convenience.

Still another method to determine abnormalities may be used, such as applying OR in the error monitor (MON) results (abnormality is determined when at least one node reports an “error”), or applying AND in the results (abnormality is determined when all the nodes report an “error”).

In the abnormality identification (ID1) process or the counter-value-transmission target selection process performed within the flow shown in FIG. 4, it is better to rotate target nodes so that if a node fault occurs, the effect of the error can be kept minimal.

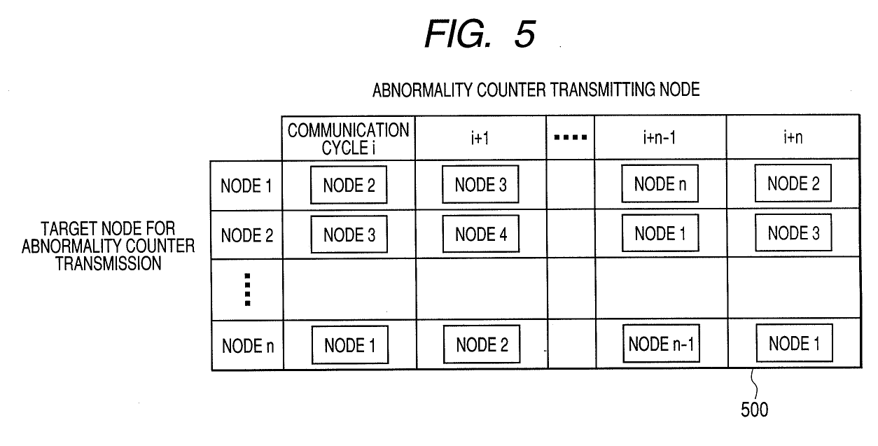

FIG. 5 shows an example of a target node rotation schedule. In schedule 500, a node responsible for a node 1 will be a node 2 in a communication cycle i, a node 3 in a communication cycle i+1, a node n in a communication cycle i+n−1, and so on. The node keeps changing until one rotation cycle is completed at the node 2 in a communication cycle i+n, and the rotation repeats.

In the schedule 500, all nodes are being covered for abnormality identification (ID1) or counter-value-transmission target selection in a communication cycle. The node 2 is covered by the node 3 in the communication cycle i, the node 4 in the communication cycle i+1, the node 1 in the communication cycle i+n, and so on. The node keeps changing such as the node n is covered by the node 1 in the communication cycle i, the node 2 in the communication cycle i+1, the node n−1 in the communication cycle i+n−1, and so on. In this way, even though one node is responsible for only one other node in the abnormality identification (ID1) process, all nodes are being covered in the process for every communication cycle.

The schedule 500 may be kept as a table in a storage unit such as memory, or such a regular table can be easily calculated with a mathematical formula. Using a formula, for example, the number of the node responsible for the node 1 in the schedule 500 can be obtained by dividing a number of the communication cycle by n−1 and adding 1 to the remainder.

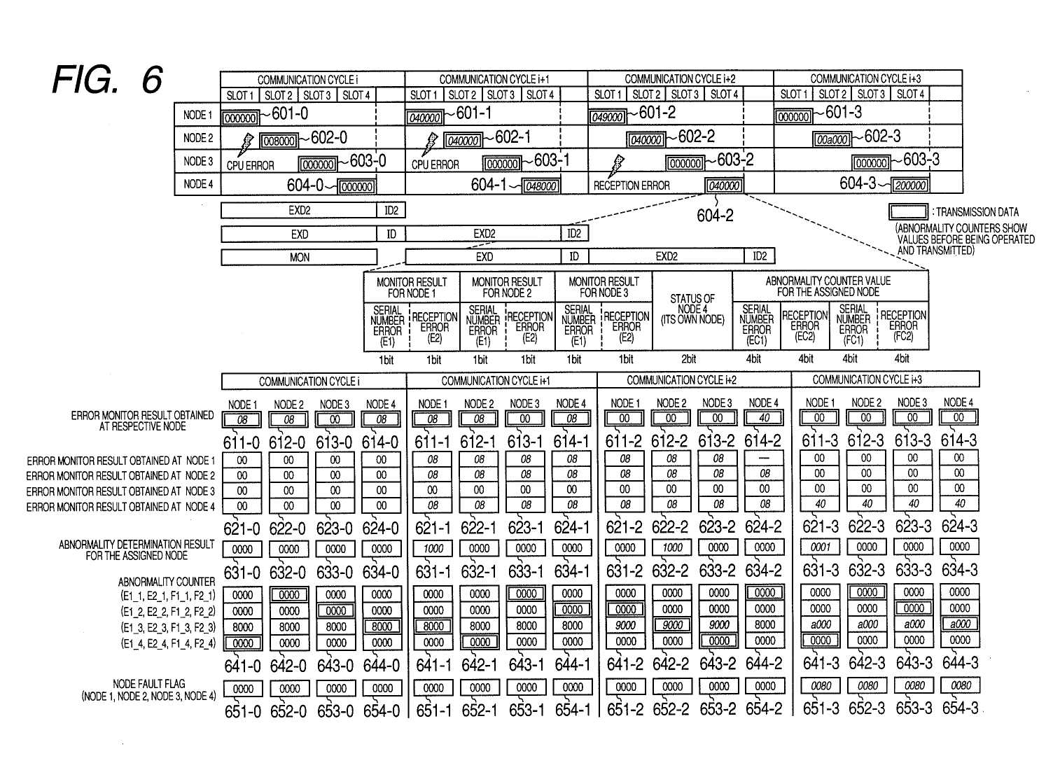

FIG. 6 illustrates an exemplary operation of the mutual node-fault monitoring with abnormality-counter transmission synchronization. The algorithm in FIG. 4 is used for the mutual monitoring.

Nodes 1 to 4 sequentially send data using slots 1 to 4, and the error monitoring (MON), abnormality identification (ID1), and abnormality determination (ID2) processes are performed at the end of each communication cycle after the completion of data exchange by each node. The “serial number error” and “reception error” described above are set as error monitor items. Abnormality counters are divided into majority-voted abnormalities and minority-voted abnormalities.

In the abnormality-counter transmission synchronization process (step 460), the node assigned for abnormality identification (ID1, step 430) is selected in the counter-value-transmission target selection process (step 220); and for the abnormality-counter synchronization condition (step 240), either the abnormality-counter synchronization condition 1 only or both abnormality-counter synchronization conditions 1 and 2 must be met. Exchange of abnormality counters (step 230) operated based on the abnormality identification (ID1) results is performed in place of the abnormality identification result exchange (EXD2, step 440), and abnormality determination (ID2, step 450) is combined with abnormality-counter synchronization (step 460). In this way, abnormality identification and abnormality-counter transmission synchronization can be reasonably and reliably performed with a minimal usage of processing resources (such as CPU capacity and memory).

In a communication cycle i, each node sends its error monitor results and temporary counter values (601-0 to 604-0, expressed in hexadecimal notation) from the previous cycle, and each node receives and stores the data (621-0 to 624-0, expressed in the same way as the transmitted data). This process corresponds to the error monitor result exchange (EXD1). The transmission data contains the error monitor (MON) results for the nodes 1-4 from the previous cycle, sequentially aligned, followed by the temporary abnormality counter values (hereinafter, “temporary counter values”) calculated in the previous cycle for the abnormality determination target node for the communication cycle. Besides these, the transmission data also includes header and control data, not shown in the figure. The error monitor result consists of a bit indicating a serial number error (E1) and a bit indicating a reception error (E2). Two bits reserved for its own node contain a self diagnosis result. The temporary counter values are represented by four bits per value, including the majority-voted abnormality counter value for serial number errors (EC1), majority-voted abnormality counter value for reception errors (EC2), minority-voted abnormality counter value for serial number errors (FC1), and minority-voted abnormality counter value for reception errors (FC2).

As shown in the figure, the node 3 has had a CPU error before sending its data, causing the serial number sent by the node 3 not to be incremented from the previous cycle. As a result, all the nodes except for the node 3, detect a serial number error for the node 3 (611-0, 612-0, 614-0, expressed in the same way as the transmission data) through error monitoring (MON). The node 3 detects no errors for itself (613-0).

Each node performs the abnormality identification (ID1) process for a communication cycle i−1 (for the errors detected through error monitoring in the communication cycle i−1) at the end of the communication cycle i. Here, the gathered error monitor results (621-0 to 624-0) for the communication cycle i−1 show no error items getting a majority, hence no errors are identified (631-0 to 634-0, expressed in binary notation, the configuration is the same as a node-fault flag for a single node, the node-fault flag is described later). In the communication cycle i, the nodes 1, 2, 3, and 4 are in charge of the nodes 4, 1, 2, and 3 respectively.

Each node has a set of abnormality counters including a majority-voted abnormality counter for serial number errors E1_j, a majority-voted abnormality counter for reception errors E2_j, a minority-voted abnormality counter for serial number errors F1_{—}j, and a minority-voted abnormality counter for reception errors F2_{—}j (j is a target node number, 1-4). Each counter keeps the value unchanged when no abnormalities are identified.

The counters are configured in a way which, upon a receipt of temporary counter values, each node compares each of the received counter values with the counter values kept in itself, and when the received temporary counter value is +1 to −1 from its own counter value, sets its own counter value to the temporary counter value (the abnormality-counter synchronization condition 1). Even when the above condition is not met, if the temporary counter value received in the current cycle is within a range of +1 to −1 compared to the temporary counter value received in the previous cycle, the node sets its own counter value to the temporary counter value received in the current cycle (the abnormality-counter synchronization condition 2).

The nodes 1, 2, 3, and 4 have sent temporary counter values for the nodes 2, 3, 4, and 1 respectively; and in the data sent from each node, EC1 for the node 3 is “8” while all the others are “0”. Therefore, in the abnormality counters for each node, only the majority-voted abnormality counter for serial number errors for node 3 (E1_3) shows “8” while all the other counters are “0” (641-0 to 644-0, in hexadecimal notation).

The threshold value for node-fault notification is set to “10” (a notification is sent at “10”), therefore no node-fault flags are turned on at this moment (651-0 to 654-0, octal notation).

A node-fault flag contains bits representing nodes 1 to 4 in sequence, four bits per node, the four bits are a bit indicating serial number errors by majority-voted abnormality (related to the abnormality determination condition 1); a bit indicating reception errors by majority-voted abnormality; a bit indicating serial number errors by minority-voted abnormality (related to the abnormality determination condition 2); and a bit indicating reception errors by minority-voted abnormality.

In a communication cycle i+1, each node is to send its error monitor results from the previous cycle, therefore the error bits E1 for the node 3 are tuned on in the data sent by the nodes 1, 2, and 4 (601-1, 602-1, 604-1). No error bits are turned on in the data sent by the node 3 (603-1).

In this cycle, the node 3 has had a CPU error again before sending its data, causing the serial number sent by the node 3 not to be incremented from the previous cycle. As a result, all the nodes except for the node 3 detect a serial number error for the node 3 (611-1, 612-1, 614-1) through error monitoring (MON). The node 3 detects no errors for itself (613-1).

In the abnormality identification (ID1) process for the communication cycle i, which is performed at the end of the communication cycle i+1, since the data showing the serial number error for the node 3 get a majority in the gathered error monitor results (621-1 to 624-1), the node 3 is identified as having a serial number error by majority-voted abnormality. Since, in the communication cycle i+1, the nodes 1, 2, 3, and 4 are in charge of the nodes 3, 4, 1, and 2 respectively, only the node 1 determines the error (631-1) and no other nodes do (632-1 to 634-1).

Regarding the abnormality counters, each node has sent the temporary counter values for the node assigned for error monitoring (ID1) in the previous communication cycle. Since no errors have been identified, the temporary counter values and the counter values after the counter synchronization process (641-1 to 644-1) remain the same as the previous cycle. No node-fault flags are turned on yet (651-1 to 654-1).

In a communication cycle i+2, as in the communication cycle i+1, the error bits E1 for the node 3 are tuned on in the data sent by the nodes 1, 2, and 4 (601-2, 602-2, 604-2). No error bits are turned on in the data sent by the node 3 (603-2).

In this cycle, the node 4 has had a reception error in the slot 1, and as a result, only the node 4 detects a reception error for the node 1 (614-2) through error monitoring (MON). The nodes 1 to 3 detect no errors (611-2, 612-2, and 613-2).

In the abnormality identification (ID1) process for the communication cycle i+1, which is performed at the end of the communication cycle i+2, the node 3 is identified as having a serial number error by majority-voted abnormality as in the communication cycle i+1. Since, in the communication cycle i+1, the nodes 1, 2, 3, and 4 are in charge of the nodes 2, 3, 4, and 1 respectively, only the node 2 determines the error (632-2) and no other nodes do (631-2, 633-2, 634-2).

Regarding the abnormality counters, the node 1 has incremented the EC1 for the node 3 to “9” based on the abnormality identification (ID1) results in the previous communication cycle, and sends it with the other counters (601-2). All the other temporary counter values are sent as “0” (601-2 to 604-2). Therefore, in all the nodes except for the node 4, which has had the reception error, their E1_3's are updated from “8” to “9” through abnormality-counter synchronization (641-2 to 643-2), and that of the node 4 remains “8” (644-2). No node-fault flags are turned on yet (651-2 to 654-2).

In a communication cycle i+3, the node 1 identifies the reception error by minority-voted abnormality for the node 4 based on the gathered error monitor results (621-3 to 624-3) through abnormality identification (ID1) for the communication cycle i+2, which is performed at the end of the communication cycle.

Regarding the abnormality counters, the node 2 has incremented the EC1 for the node 3 to “10 (0xa)” based on the abnormality identification (ID1) results in the previous communication cycle, and sends it with the other counters (602-3). Therefore, in all the nodes, its E1_3 is updated from “9” to “10 (0xa)” through abnormality-counter synchronization (641-3 to 643-3), the node-fault flag for the node 3 indicating serial number errors by majority-voted abnormality is turned on, and an error notification is sent to the control application (651-3 to 654-3).

As described above, this process can achieve highly reliable error monitoring as well as robust abnormality-counter synchronization and simultaneous transmission of an error notification in all nodes. On the other hand, in the imminent flag synchronization process, a flag is turned on in the communication cycle i+3 and the E1_3 in the node 4 becomes “9”, but in the meantime, the E1_3s in the nodes 1 to 3 reach “10”, resulting in the sending of error notifications. The counter in the node 4 remains “9” until the abnormality is determined by itself.

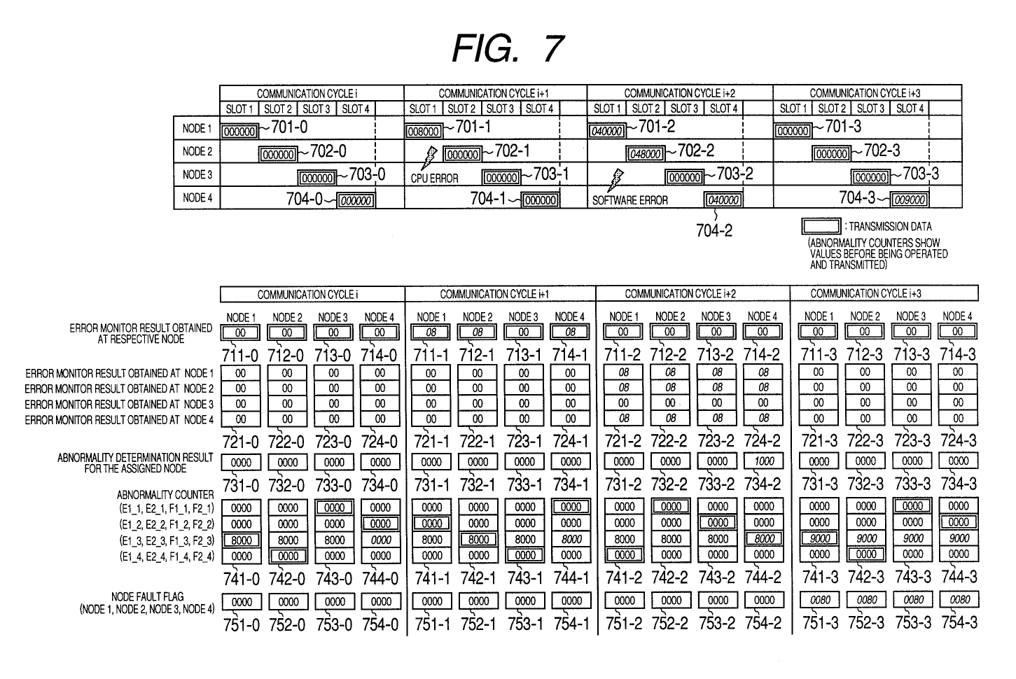

FIG. 7 illustrates an exemplary operation of the mutual node-fault monitoring, which is performed based on the same rules as described in FIG. 6. This example shows the procedures to synchronize abnormality counters with the other nodes' counters when the counters have been reset due to some kind of error in its own node identified through self diagnosis. In this example, every counter has a flag indicating its reset status. “Reset” means to turn on this flag, and “unreset” means to turn off this flag.

Before a communication cycle i, a node 4 has reset its own counters, hence the abnormality counters are in reset status with values “0”. Nodes 1 to 3 have “8” in their E1_3s and “0” in all the other counters. The node 4 participates in the communication and mutual monitoring starting from the communication cycle i.

The error monitor results for the previous cycle, sent by each node in the communication cycle i, contain no reported errors, hence the temporary counter values are “0” (701-0 to 704-0). The node 4 sends EC1 for the node 3, but since the value is “0”, the other nodes do not synchronize with this temporary counter value, therefore the E1_3s in the other nodes remain “8” (741-0 to 743-0). The E1_3 in the node 4 remains “0” (744-0).

The exchanged error monitor results show no detected errors (721-0 to 724-0), therefore no errors are identified through abnormality identification (ID1) (731-0 to 734-0). No errors are detected through error monitoring (MON) either (711-0 to 714-0). No node-fault flags are turned on (751-0 to 754-0).

In a communication cycle i+1, the node 3 has had a CPU error before sending its data, causing the serial number in the transmission data not to be incremented. As a result, all the nodes except for the node 3, detect a serial number error for the node 3 (711-1, 712-1, 714-1) through error monitoring (MON). The node 3 detects no errors for itself (713-1). Since the gathered error monitor results (721-1 to 724-1) for the communication cycle i contain no error items getting a majority, no errors are identified (731-1 to 734-1).

Regarding the abnormality counters, the node 1 has sent “8” as the EC1 for the node 3 (701-1). The E1_3s in the nodes 2 and 3 that have been “8”, hence remain as “8” (742-1, 743-1). On the other hand, since the E1_3 in the node 4 is in a reset status, the node is unreset by updating the counter to “8” (744-1). The E1_3 is only temporarily synchronized at this moment, and a provided temporary synchronization flag is turned on to indicate the status.

In a communication cycle i+2, all the nodes except for the node 3 report the serial number error (E1) for the node 3 in their transmission data as the error monitor result for the previous cycle (701-2, 702-2, and 704-2). In the abnormality identification (ID1) process, since the data indicating the serial number error for the node 3 get a majority in the gathered error monitor results (721-2 to 724-2), the serial number error by majority-voted abnormality for the node 3 is identified. In this communication cycle, the node 4 is in charge of the node 3, therefore only the node 4 determines the error (734-2) and no other nodes do (731-2 to 733-1).

Regarding the abnormality counters, the node 2 has sent the EC1 for the node 3 (702-2). The E1_3s in the nodes 1 and 3 are synchronized and remain “8”. The node 4 is supposed to follow that, but it has an internal software error and wrongly receives the EC1 for the node 3 as “4” from the node 2. The node 4 also fails to consecutively synchronize its E1_3, hence the E1_3 is reset and the temporary synchronization flag is turned off. The counter value may also be set to “0”, however in this embodiment, the value is kept at “8” (744-2).

In a communication cycle i+3, the node 4 sends the EC1 for the node 3. Since the E1_3 in the node 4 is in a reset status, it is acceptable to send an invalid value (for example, “0xF” which is larger than “10”, “10” is the threshold for node-fault notification). In this embodiment, “9” is sent (704-3), which is a number incremented by 1 from the temporary value “8” based on the abnormality identification (ID1) results in the previous cycle. Consequently, the E1_3s in the nodes 1 to 3 are synchronized to “9” (741-3 to 743-3). The E1_3 for the node 4 will be synchronized with the EC1 if “8” to “10” is received as the EC1 for the node 3 in the next communication cycle, because the abnormality-counter synchronization condition 2 will be satisfied with respect to the previously received value of “8”. This synchronization may be temporary or permanent. If the EC1 for the node 3 in the next communication cycle is not the value mentioned above, the E1_3 in the node 4 will be temporarily synchronized with the received value.

As described above, the abnormality counters in a reset status can be synchronized also using the process flow in FIG. 2.

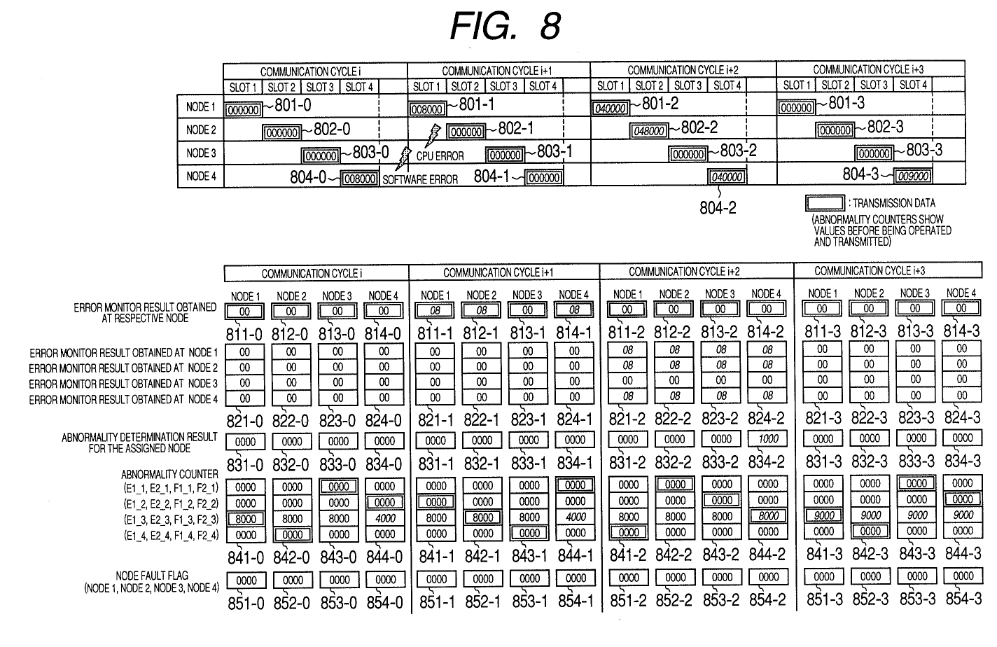

FIG. 8 illustrates an exemplary operation of the mutual node-fault monitoring, which is performed based on the same rules as described in FIG. 6. This example shows the procedures to synchronize an abnormality counter with the other nodes' counters when the abnormality counter has a wrong value in it due to some kind of error such as a software error.

The data sent from each node in a communication cycle i show no errors reported in the error monitor results for the previous cycle. For the temporary counter values, EC1 for a node 3 sent by a node 4 is “8” and all the others are “0” (801-0 to 804-0). Through abnormality-counter synchronization, E1_3 in each node becomes “8” and the other counters become “0” (841-0 to 843-0), except for the node 4, which has a software error, whose E1_3 becomes “4” (844-0). No node-fault flags are turned on (851-0 to 854-0).

In a communication cycle i+1, the node 3 has had a CPU error before sending its data, causing the serial number in the transmission data not to be incremented. As a result, all the nodes except for the node 3, detect a serial number error for the node 3 (811-1, 812-1, 814-1) through error monitoring (MON). The node 3 detects no errors for itself (813-1). Since the gathered error monitor results (821-1 to 824-1) for the communication cycle i contain no error items getting a majority, no errors are identified (831-1 to 834-1).

Regarding the abnormality counters, the node 1 sends the EC1 for the node 3 (801-1). Through abnormality-counter synchronization, the E1_3s in the nodes 1 to 3 remain “8” (841-1, 843-1). On the other hand, the E1_3 in the node 4 fails to be synchronized, hence remains “4” (844-1).

In a communication cycle i+2, all the nodes except for the node 3 report the serial number error (E1) for the node 3 in their transmission data as the error monitor result for the previous cycle (801-2, 802-2, and 804-2). In the abnormality identification (ID1) process, since the data indicating the serial number error for the node 3 get a majority in the gathered error monitor results (821-2 to 824-2), the serial number error by majority-voted abnormality for the node 3 is identified. In this communication cycle, the node 4 is in charge of the node 3, therefore only the node 4 determines the error (834-2) and no other nodes do (831-2 to 833-2).

Regarding the abnormality counters, the node 2 sends the EC1 for the node 3 (802-2). Through abnormality-counter synchronization, the E1_3s in the nodes 1 to 3 remain “8” (841-2, 843-2). On the other hand, the E1_3 in the node 4 fails to be synchronized, but since it has consecutively failed to be synchronized, it is temporarily synchronized to “8” (844-2, the limit of consecutive failure, is set to “2”).

Regarding the abnormality counters in a communication cycle i+3, the node 4 is in charge of sending the EC1 for the node 3. The node 4 sends “9”, which is a number incremented from the temporarily synchronized value of “8”, based on the abnormality identification (ID1) results in the previous cycle (802-3). Through abnormality-counter synchronization, the E1_3s in the nodes 1 to 3 become “9” (841-3 to 843-3). The E1_3 in the node 4 also becomes “9” (844-3), but its synchronization status remains temporary until the synchronization is finalized in the next communication cycle or later. It may be configured to send an error notification regardless of its temporarily synchronized status, when the counter value becomes equal to or greater than the threshold of “10”.

As described above, an abnormality counter can be synchronized through the process flow described in FIG. 2, even when it has a wrong value (not synchronized with counters in other nodes) due to some kind of error.

### Embodiment 2

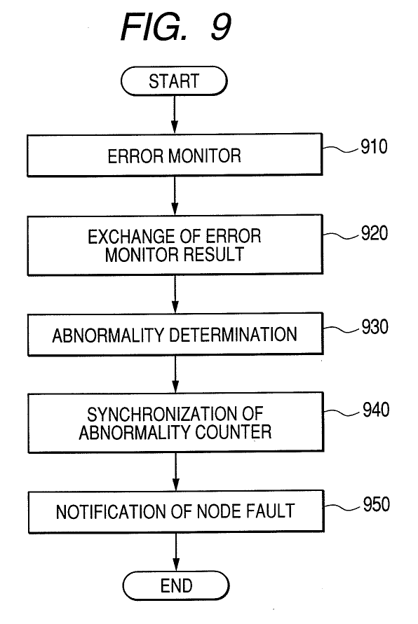

FIG. 9 shows a flow chart of abnormality identification processes based on mutual node-fault monitoring. These processes are performed in sync among all the nodes, e.g. for every communication cycle, while communicating with each other via the network 100.

Error monitoring in step 910 is the same as that in step 410. In the next step 920, the send/receive processing unit 141-i exchanges the error monitor results among the nodes obtained in step 910, via the network 100 in the same manner as the error monitor result exchange in step 420.

Next, in step 930, the abnormality determination unit 143-i determines errors (ID) based on the error monitor (MON) results gathered in each node in step 920. The method to determine errors is the same as that of step 430. In step 430, one node performs the abnormality identification process on only one other assigned node. However, in this step, a node is responsible for the abnormality determination of all nodes. This is different from the process described in FIG. 4. No rotation of target nodes takes place since each node covers all other nodes.

Next, in step 940, the counter synchronization unit 145-i synchronizes abnormality counters. When the abnormality-counter transmission synchronization method is used, the processes described in FIG. 2 are performed in step 470. In addition, the counter unit 144-i allows the original abnormality counters to reflect the counter values after the abnormality-counter synchronization process. The abnormality counters may be divided into majority-voted abnormalities and minority-voted abnormalities as done in the process described in FIG. 4.

In the abnormality-counter transmission synchronization process, a temporary operation of abnormality counters (step 210) is performed first. Abnormality counters are operated based on the abnormality determination (ID) results in step 930. The operated counter values are stored in a different region from the original abnormality counters. The operation method for the abnormality counters is the same as that of step 450.

The next step 950 is the same as the notification of node fault in step 470. After the node-fault notification is completed, the process will end.

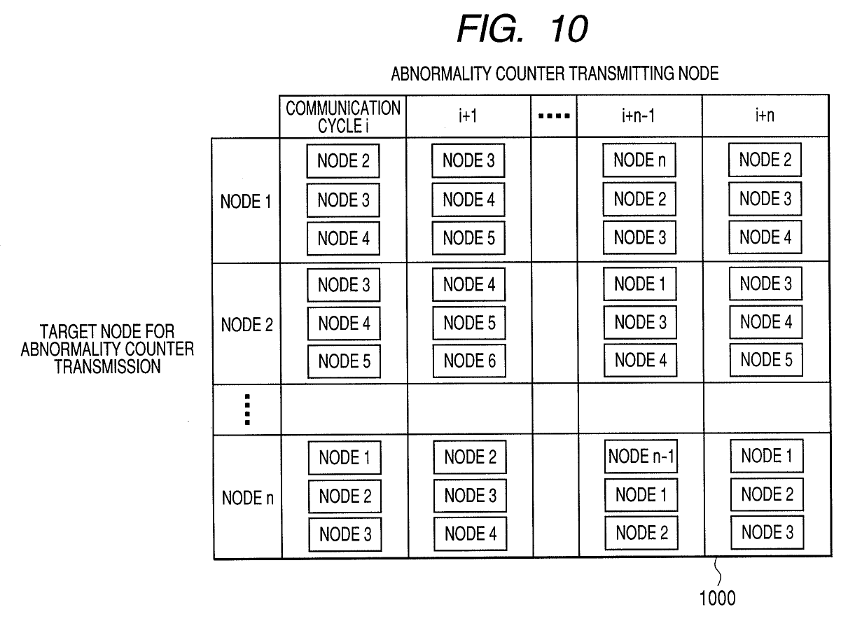

In the counter-value-transmission target selection process performed within the flow shown in FIG. 9, it is better to rotate target nodes so that if a node fault occurs, the effect of the error can be kept minimal. FIG. 10 shows an example of a target node rotation schedule. In a schedule 1000, the nodes that are responsible for node 1 will be nodes 2, 3, and 4 in a communication cycle i; nodes 3, 4, and 5 in a communication cycle i+1; nodes n, 2, and 3 in a communication cycle i+n−1, and so on. The nodes keep changing until one rotation cycle is completed at the nodes 2, 3, and 4 in a communication cycle i+n, and the rotation repeats.

In the schedule 1000, each node is being covered by three other nodes for counter-value-transmission target selection in a communication cycle. In this way, a majority vote can be taken to calculate synchronization counter values. The schedule 1000 may be stored as a table in a storage unit such as memory, or it can be easily calculated with a mathematical formula.

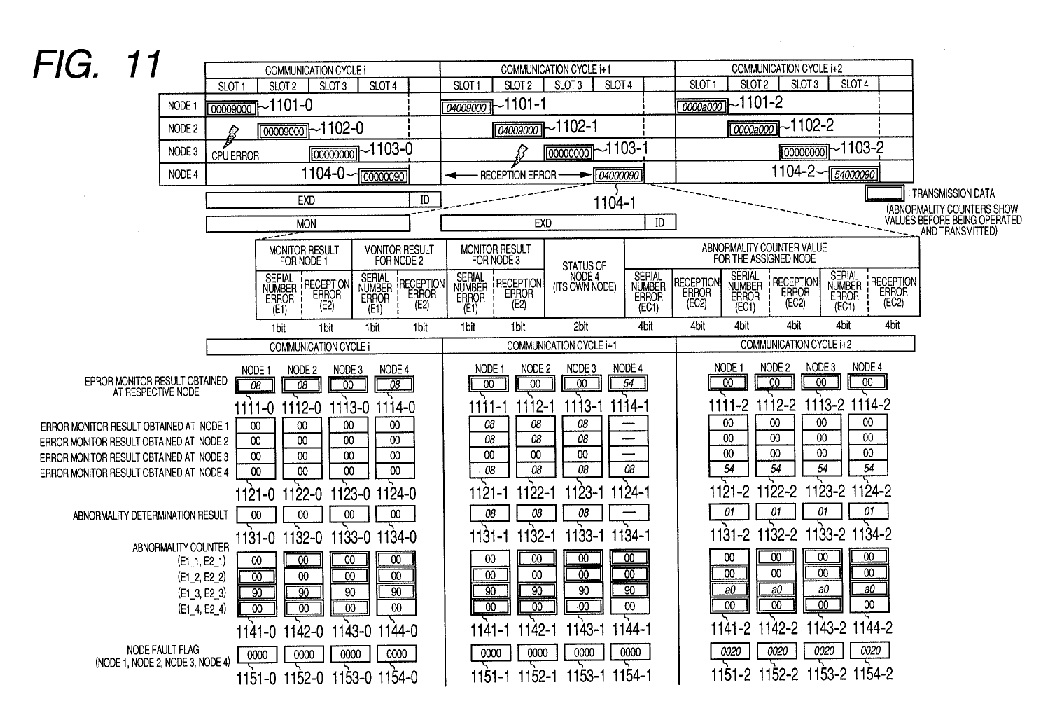

FIG. 11 illustrates an exemplary operation of the mutual node-fault monitoring with abnormality-counter transmission synchronization. The algorithm in FIG. 4 is used for the mutual monitoring.

In the abnormality-counter transmission synchronization process (step 940): a plurality of nodes are rotated for every communication cycle as in FIG. 10 to be selected in the counter-value-transmission target selection (step 220); the abnormality-counter synchronization condition 3 must be met for the abnormality-counter synchronization condition (step 240); and synchronization counter values are determined (step 240) by taking a majority vote on the received counter values. In this way, the abnormality determination and abnormality-counter transmission synchronization can be reasonably and reliably performed.

The other settings such as error monitor items are configured in the same way as in Embodiment 1 unless otherwise noted. One exception are the abnormality counters, which are not divided into majority-voted abnormalities and minority-voted abnormalities. The abnormality counters E1_{—}j and E2_{—}j are incremented when either of a majority-voted abnormality or a minority-voted abnormality is determined, or else, if neither are determined, the counter values remain the same.

In a communication cycle i, nodes 1 to 4 sequentially send the error monitor results and temporary counter values for the previous cycle using slots 1 to 4 (1101-1 to 1104-1, expressed in hexadecimal notation), and each node receives and stores the data (1121-0 to 1124-0, in hexadecimal notation). Regarding the temporary counter values, each node is in charge of three other nodes, and a value for serial number errors (EC1) and a value for reception errors (EC2) are provided for each node. These values are lined sequentially, in transmission data, by the node number following the error monitor results. For example, the data sent by the node 2 contain values for the nodes 1, 3, and 4 in order.

In each node, EC1 for the node 3 is “9” and the others are “0”. Consequently, E1_3 in each node remains “9” and other counter values remain “0” after the abnormality-counter synchronization process (1141-0 to 1144-0).

In addition, in this communication cycle, the node 3 has had a CPU error before sending its data, causing the serial number in the transmission data not to be incremented. As a result, all the nodes except for the node 3 detect a serial number error for the node 3 (1111-0, 1112-0, 1114-0) through error monitoring (MON) The node 3 detects no errors for itself (1113-0). Since the gathered error monitor results (1121-0 to 1124-0) for the communication cycle i have no error items getting a majority, no abnormalities are determined (1131-1 to 1134-1, expressed in the same way as the error monitor result). No node-fault flags are turned on (1151-0 to 1154-0, in ternary notation).

The node-fault flag contains bits representing the nodes 1 to 4 in sequence, two bits per node; the two bits are a bit indicating serial number errors and a bit indicating reception errors, both by the abnormality determination condition 1.

In a communication cycle i+1, the node 4 has had a reception error at the slots 1 to 3. The node 4 detects reception errors for the nodes 1 to 3 (1114-1) through error monitoring (MON), but no other nodes detect the error (1111-1 to 1113-1).

In the abnormality determination (ID) process in this communication cycle, the serial number error (majority-voted abnormality) for the node 3 is determined in the nodes 1 to 3 because a majority of data indicate the serial error for the node 3 in the gathered error monitor results (1121-1 to 1123-1). Since the node 4 was unable to receive data from the other nodes, it could not perform a majority vote in the abnormality determination (ID) process, therefore no abnormalities are determined (1124-1).

Regarding the abnormality counters, each node has “9” for the EC1 for the node 3 and “0” for the other counters. Consequently, the E1_3s in the nodes 1 to 3 remain “9” and the other counter values remain “0” (1141-1 to 1143-1) after the abnormality-counter synchronization process. The abnormality counters in the node 4 cannot be synchronized, hence its E1_3 remains “9” and the other counter values remain “0” (1144-1).

In the data sent by each node in a communication cycle i+2, the nodes 1 to 3 report no errors (1101-2 to 1103-2) in the error monitor results, but the node 4 reports reception errors for the nodes 1 to 3 (1104-2). Regarding the temporary counter values in the transmission data, the EC1s for the node 3 in the nodes 1 and 2 are “10 (0xa)”, which is a number incremented from the value based on the abnormality determination (ID) results in the previous communication cycle (1101-2, 1102-2). On the other hand, in the node 4, the EC1 for the node 3 remains “9” (1104-2) as it was in the previous communication cycle since the abnormality determination (ID) could not be performed in the previous communication cycle. The temporary counter values in the data sent by the node 3 are all “0” since the data include no values for the node 3 itself (1103-2).

In the abnormality determination (ID) process in this communication cycle, a reception error (minority-voted abnormality) for the node 4 is determined from the gathered error monitor results (1121-2 to 1124-2) in each node (1131-2 to 1134-2). These abnormality determination results will be reflected in the temporary counter values sent in the next communication cycle.

Regarding the abnormality counters, two nodes show “10” and one node shows “9” for the EC1 for the node 3 in their data (the data structure not shown in FIG. 11), therefore by majority voting, the E1_3 in each node is synchronized to “10 (0xa)” (1141-2 to 1144-2). Since the E1_3 counter value in each node reaches the threshold of “10”, the node flag indicating a serial error for the node 3 is turned on and an error notification is sent to each control application (1151-2 to 1154-2).

As describe above, highly reliable and robust abnormality determination and abnormality-counter synchronization processes can both be achieved at the same time.

### Embodiment 3

The process of each step in FIG. 9 may be changed as required. Modification examples for the process of each step in this embodiment are described below.

In step 920, each node may first perform the temporary operation of abnormality counters of step 210, based on the error monitor (MON) results by itself, and exchange the temporary counter values as the error monitor results in step 930. This step 930 includes the abnormality counter exchange process of step 230. The abnormality determination (ID) in step 930 and the abnormality-counter synchronization in step 940 may be performed together by taking a majority vote on (or taking a median value of) the temporary counter values received from each node. In other words, incrementing a counter value through the abnormality-counter synchronization means an abnormality is determined, and decrementing the counter or keeping it unchanged means no abnormalities are determined. In step 940, only the abnormality-counter synchronization condition determination and execution (step 240) described in FIG. 2 are performed.

By performing the above processes, the steps to the abnormality-counter synchronization can be one step shorter than Embodiment 2.

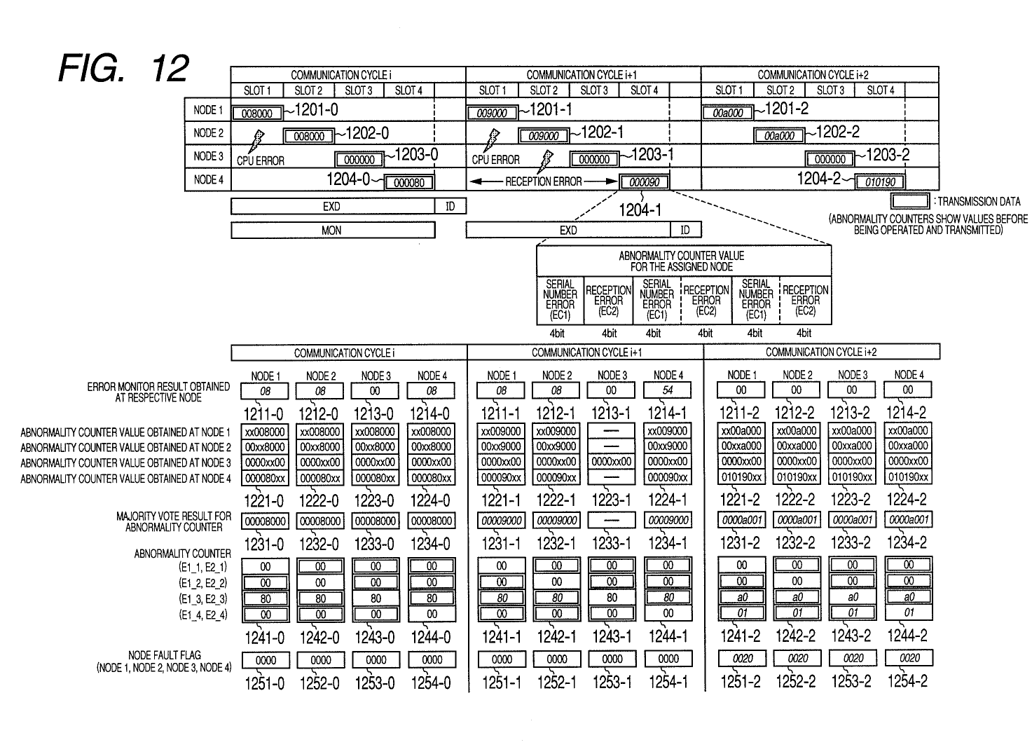

An exemplary operation of the mutual node-fault monitoring using the above-mentioned modified process flow of FIG. 9 is shown in FIG. 12, and is described below. The settings such as error monitor items are the same as those in Embodiment 2 unless otherwise noted.

In a communication cycle i, nodes 1 to 4 sequentially send their temporary counter values reflecting the error monitor (MON) results for the previous cycle using slots 1 to 4 (1201-1 to 1204-1, expressed in hexadecimal notation), and each node receives and stores the data (1221-0 to 1224-0, in hexadecimal notation). Regarding the temporary counter values, each node is in charge of three other nodes; a value for serial number errors (EC1) and a value for reception errors (EC2) are provided for each assigned node; and the values are lined in order of the node number in transmission data. For example, the data sent by the node 2 contains the values for the nodes 1, 3, and 4 in order. In the temporary counter values received from the other nodes (1221-0 to 1224-0), values for its own node are added (expressed in “xx”) and lined in order of the node number.

In each node, EC1 for the node 3 is “8” and the other values are “0”. Consequently, by taking a majority vote through the abnormality-counter synchronization process (1231-0 to 1234-0), E1_3 in each node remains “8” and the other counter values remain “0” (1241-0 to 1244-0). No node-fault flags are turned on (1251-0 to 1254-0, in ternary notation).

In addition, in this communication cycle, the node 3 has had a CPU error before sending its data, causing the serial number in the transmission data not to be incremented. As a result, all the nodes except for the node 3 detect a serial number error for the node 3 (1211-0, 1212-0, 1214-0) through error monitoring (MON) The node 3 detects no errors for itself (1213-0).

In the data sent by the nodes 1, 2, and 4 in a communication cycle i+1, the serial number error for the node 3 detected through error monitoring (MON) in the previous communication cycle is reflected and incremented to “9” in the EC1s for the node 3 (1201-1, 1202-1, 1204-1). All the other temporary counter values are “0”, as well as the temporary counter values sent by the node 3 (1203-1). Unfortunately, the node 4 has reception errors in the slots 1 to 3, and detects reception errors for the nodes 1 to 3 (1214-1). In addition, the node 3 again has had a CPU error before sending its data, resulting in the nodes 1 and 2 detecting a serial number error for the node 3 (1211-1, 1212-1).

By taking a majority vote through the abnormality-counter synchronization process in this communication cycle (1231-1, 1232-1, 1234-1), the E1_3 in each node, except for the node 3 with a reception error, becomes “9”, and all the other counter values remain “0” (1241-1, 1242-1, 1244-1). A majority vote cannot be taken on the temporary counter values in the node 3 (1233-1), hence the E1_3 in the node 3 remains “8” (1243-1).

In the data sent by the nodes 1 and 2 in a communication cycle i+2, the serial number error for the node 3 detected through error monitoring (MON) in the previous cycle is reflected and incremented to “10 (0xa)” in the EC1s for the node 3 (1201-2, 1202-2). In the node 4, EC2s for the nodes 1 and 2 are incremented to “1” and the EC1 for the node 3 remains “9” (1204-2). In the node 3, all temporary counter values are “0” (1203-2). Since no errors have occurred in this cycle, no errors are detected through error monitoring (MON) (1211-2 to 1214-2).

By taking a majority vote through the abnormality-counter synchronization process in this communication cycle (1231-2 to 1234-2), the E1_3 in each node becomes “10 (0xa)”. The counter values for the node 4 are determined as “0” by a simple majority vote; however, it is recognized that only the node 4 has detected reception errors for the nodes 1 and 2, by comparing the temporary counter values sent by the node 4 with “0” determined by the majority vote. Therefore the node 4 is considered as having a reception error by minority-voted abnormality, and the E2_4 in each node is incremented from “0” (from the majority vote) to “1”. All the other counter values remain “0” (1241-2 to 1244-2).

Since the E1_3 in each node reaches the threshold value of “10”, the node flag indicating a serial number error for the node 3 is turned on, and an error notification is sent to each control application (1251-2 to 1254-2).

As describe above, highly reliable and robust abnormality determination and abnormality-counter synchronization processes can both be achieved at the same time. In addition, they can be executed in shorter steps.

### INDUSTRIAL APPLICABILITY

Distributed control systems are used in a wide variety of industrial fields such as vehicles, construction machines, and FA (Factory Automation), etc. Application of the present invention to such distributed control systems can enhance system availability while maintaining high reliability.

What is claimed is:

1. A distributed system having a plurality of nodes connected via a network, each node comprising:
an error monitor unit for monitoring an error in each of the other nodes;
a send/receive processing unit for sending and receiving data for detecting abnormalities in the other nodes, to and from each of the other nodes via the network, thereby exchanging error monitor results;
an abnormality determination unit for determining which node has an abnormality, based on the exchanged error monitor results;
a counter unit for counting occurrences of the abnormality for the node which is determined as having the abnormality; and
a counter synchronization unit for synchronizing abnormality counter values when an abnormality-counter synchronization conditions is satisfied, after exchanging the counter values with each of the other nodes.

2. The distributed system according to claim 1, wherein the abnormality-counter synchronization condition requires a received abnormality counter value to be within a specified range from a counter value of its own node.

3. The distributed system according to claim 2, wherein a node assignment is rotated every abnormality determination cycle, the node for which abnormality counter values are exchanged.

4. The distributed system according to claim 1, wherein, in spite of a failure to meet the abnormality-counter synchronization condition, the abnormality counter is temporarily synchronized if it is in a reset status; and thereafter, finalizes the synchronization if it consecutively satisfies the abnormality-counter synchronization condition for a specified number of times.

5. The distributed system according to claim 1, wherein the abnormality counter is reset when it consecutively fails to satisfy the abnormality-counter synchronization condition for a specific number of times.

6. The distributed system according to claim 1, wherein a majority vote is taken on the received counter values to determine an abnormality-counter synchronization value, and a success of the majority vote is an abnormality-counter synchronization condition.

7. The distributed system according to claim 1, wherein the abnormality counter values exchanged by the counter synchronization unit reflect values not based on the abnormality determination results, but based on the error monitor results.
